(19) United States
(12) Patent Application Publication
(10) Pub. No.: US 2007/0089413 A1
(43) Pub. Date: Apr. 26, 2007

(54) Turbo catalyst light-off device

(76) Inventors: Edward Green, Howell, MI (US); Arthur J. Spohn, Sterling Heights, MI (US); Christopher Barron, St. Clair Shores, MI (US); John R. Bucknell, Royal Oak, MI (US); David K. Ganss, South Lyon, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/255,328

(22) Filed: Oct. 21, 2005

(51) Int. Cl. F02D 23/00; F02B 33/44

(52) U.S. Cl. 60/600; 60/602; 60/605.1

(57) ABSTRACT

A turbine housing for an engine turbocharger includes a turbine outlet port fluidly coupled to an expansion mechanism, a waste port fluidly coupled to a collector, and a valve assembly rotatable between a first position blocking the turbine outlet port and a second position blocking the waste port. The valve assembly directs exhaust gas through the waste port in the first position and directs exhaust gas through the turbine outlet port in the second position. The valve assembly is in the first position during engine start-up to direct exhaust gas from the engine through the collector and into a catalyst. The valve assembly is in the second position a predetermined time following engine start-up to direct exhaust gas from the engine to the expansion mechanism.

### FIELD OF THE INVENTION

The present invention relates to exhaust gas turbochargers and, more particularly, to an exhaust gas turbocharger having a variable waste gate.

### BACKGROUND OF THE INVENTION

Current turbocharger designs are efficient at harnessing energy from a vehicle exhaust stream to increase the power output of a vehicle engine without decreasing the fuel economy of the vehicle. Conventional turbocharger devices typically include a turbine wheel and a compressor wheel mounted on a shaft within a bearing housing. An exhaust stream from the engine spins the turbine wheel and pulls air into the bearing housing. The air is pressurized in the bearing housing by the compressor wheel and is then directed to an engine intake manifold.

Directing compressed air to the engine intake manifold increases the air or air/fuel mixture density of the vehicle engine and, thus, increases the power generated by the engine. However, because the speed of the compressor is dependent on the pressure of the exhaust stream, there is generally not enough pressure at the beginning moments of vehicle acceleration, causing turbo “lag” and too much pressure at the final moments of vehicle acceleration. Because most turbochargers are capable of delivering enough pressure at peak engine levels to damage the engine, a waste gate is commonly used to vent extra pressure.

Conventional waste gate valves selectively vent excess exhaust gas to atmosphere following cleansing by a catalyst. Such waste gate valves are typically separate from existing inlet and outlet ports of the turbine and are not typically open during engine start-up when pressure in the turbocharger is relatively low.

### SUMMARY OF THE INVENTION

A turbine housing for an engine turbocharger includes a turbine outlet port fluidly coupled to an expansion mechanism, a waste port fluidly coupled to a collector, and a valve assembly rotatable between a first position blocking the turbine outlet port and a second position blocking the waste port. The valve assembly directs exhaust gas through the waste port in the first position and directs exhaust gas through the turbine outlet port in the second position. The valve assembly is in the first position during engine start-up to direct exhaust gas from the engine through the collector and into a catalyst. The valve assembly is in the second position a predetermined time following engine start-up to direct exhaust gas from the engine to the expansion mechanism.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an elevation view of a turbocharger in accordance with the principles of the present invention;

FIG. 2 is a perspective view of a turbine housing collector of the turbocharger of FIG. 1 with a valve moving between a turbine outlet port and a waste port; and

FIG. 3 is a perspective view of a turbine housing collector of the turbocharger of FIG. 1 with a valve moving between a waste port and a turbine outlet port.

### DETAILED DESCRIPTION OF THE PREFERRED EMBODIMENTS

With reference to the figures, a turbocharger includes a turbine housing 12 defining a turbine outlet port 14 and a waste port 16. The turbine outlet port 14 directs exhaust gas from an engine 11 through a turbine 13 of an expansion device 15. The exhaust gas exits the expansion device 15 and enters a collector 17 and a catalyst 20 prior to being expelled into the atmosphere. The waste port 16 bypasses the expansion device 15 and directs exhaust gas directly from the engine 11 to the catalyst 20 via collector 17 prior to expelling the exhaust gas to the atmosphere.

An actuation mechanism 22 is provided for positioning a valve assembly 24 between an outlet-bypassing position and a waste position. The valve assembly 24 bypasses exhaust gas around the turbine 13 through the waste port 16 in the outlet-bypassing position and directs exhaust gas through both the turbine 13 and the waste port 16 in the waste position.

The turbine housing 12 is fluidly coupled to an exhaust manifold 26 of the engine 11 at a collar 19 and includes the turbine outlet port 14 and the waste port 16. The turbine outlet port 14 is formed at an angle relative to the waste port 16 and includes a sealing surface 28. The sealing surface 28 matingly receives the valve assembly 24 to selectively seal the turbine outlet port 14 to prevent entry of exhaust gas. The waste port 16 similarly includes a sealing surface 30 that matingly receives the valve assembly 24 to selectively seat the waste port 16 to prevent entry of exhaust gas. It should be understood that while the turbine outlet port 14 is described as being formed at an angle relative to the waste port 16, that the turbine outlet port 14 could alternatively be positioned parallel to the waste port 16 such that the sealing surface 28 is generally co-planar with the sealing surface 30. The turbine housing 12 also includes an aperture 32 formed in a sidewall 34 for interaction with the actuation mechanism 22.

The actuation mechanism 22 includes a rod 36 that is rotatably received by aperture 32 of the turbine housing 12 and an actuator 38. The rod 36 includes a generally cylindrical shaft 40 and an arm 42 disposed generally within an interior volume 44 of the turbine housing 12. The arm 42 includes a first face 46 and a second face 48 formed on an opposite side of the arm 42 from the first face 46. The actuator 38 is connected to the rod 36 and selectively rotates the rod 36 relative to the turbine housing 12. The actuator 38 may be any suitable device capable of applying a rotational force to the rod 36, such as, but not limited to, a pneumatic device or an electric motor.

In the exemplary embodiment shown, the actuator 38 is connected to the rod 36 by an extension 43 and a crank 45 such that linear motion of the extension 43 causes rotation of the crank 45 and the rod 36. However, it should be understood that the actuator 38 may be coupled to the rod 36 in any suitable fashion that allows the actuator 38 to selectively rotate the rod 36 relative to the turbine housing 12, such as, but not limited to, being directly connected to the rod 36.

The valve assembly 24 is disposed generally within the interior volume 44 of the housing and includes a turbine outlet valve 50 and a waste valve 52. The turbine outlet valve 50 includes a sealing face 54 and is supported by the first face 46 of the arm 42. The waste valve 52 includes a sealing face 56 and is supported by the second face 48 of the arm 42. Because the first face 46 is formed on an opposite side of the arm 42 from the second face 48, the sealing face 54 of the turbine outlet valve 50 faces in a direction generally away from the waste valve 52 while the sealing face 56 of the waste valve 52 faces in a direction generally away from the turbine outlet valve 50.

In one exemplary embodiment, the sealing face 54 of the turbine outlet valve 50 faces a direction generally opposite from the sealing face 56 of the waste valve 52 such that the sealing faces 54, 56 are in a generally parallel relationship. In other exemplary embodiment, the sealing face 54 of the turbine outlet valve 50 is formed at an angle relative to the sealing face 56 of the waste valve 52.

The position of the turbine outlet port 14 relative to the waste port 16 dictates the relative position of sealing face 54 to sealing face 56. For example, if the ports 14, 16 are parallel to each other, the sealing faces 54, 56 of the valves 50, 52 will be positioned on the arm 42 in a parallel relationship. Conversely, if the turbine outlet port 14 is positioned at an angle relative to the waste port 16, the sealing face 54 of the turbine outlet valve 50 may be positioned at an angle relative to the sealing face 56 of the waste valve 52 to allow the respective sealing faces 54, 56 to properly seat against the respective sealing surfaces 28, 30 of the turbine outlet port 14 and waste port 16.

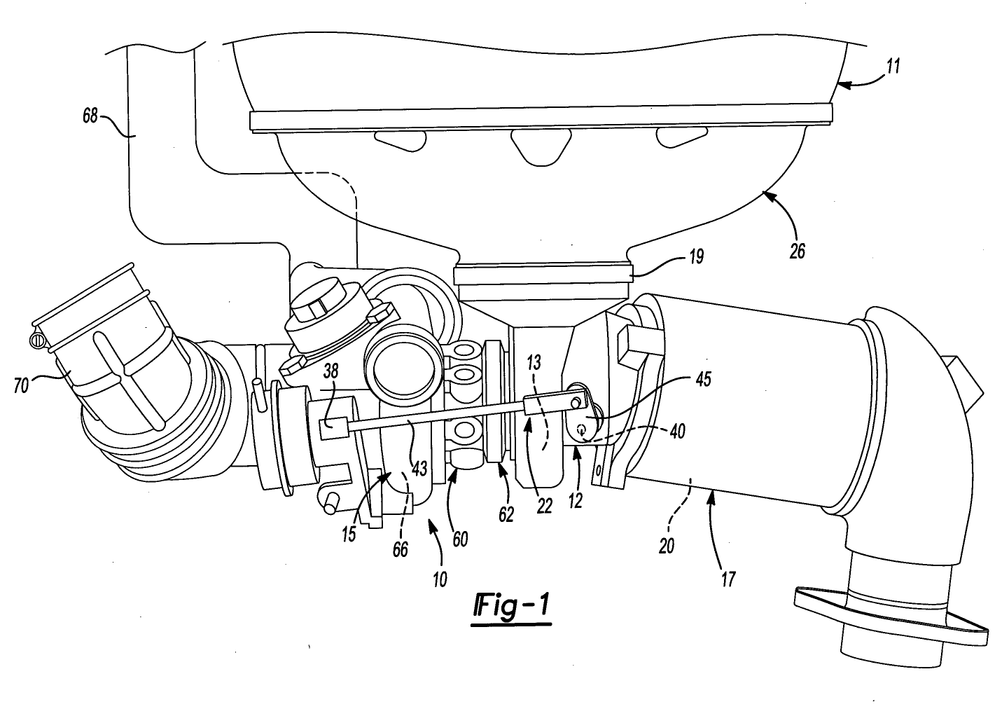

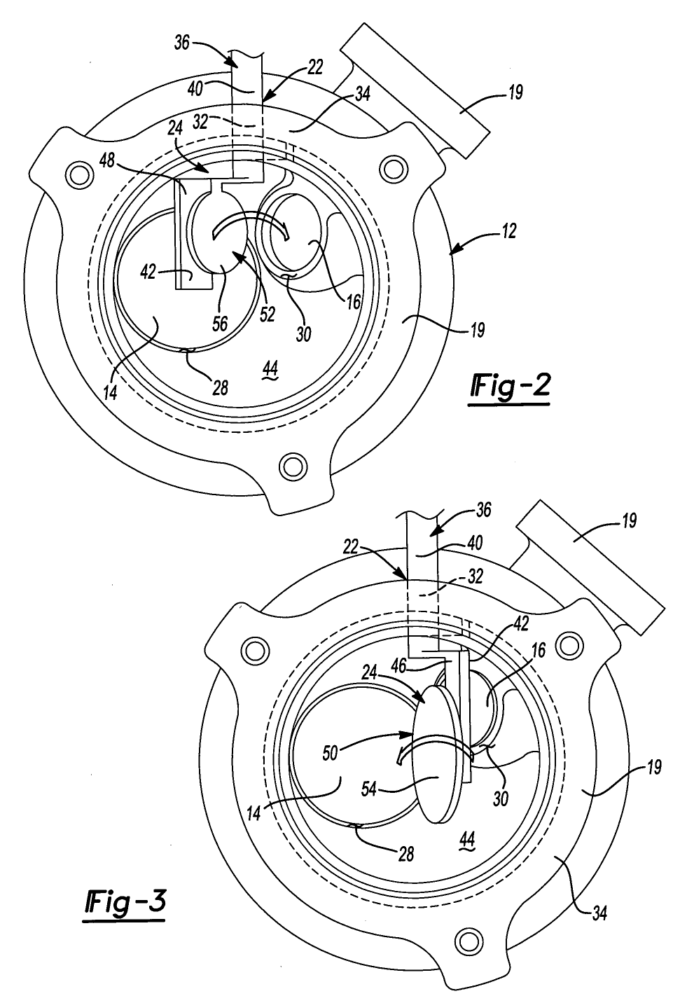

With reference to FIGS. 1-3, operation of the turbocharger 10 will be described in detail. When the engine 11 is at rest, the actuator 38 positions the rod 36 such that the sealing face 54 of the turbine outlet valve 50 abuts the sealing surface 28 of the turbine outlet port 14 to prevent exhaust gas from the exhaust manifold 26 from entering the turbine outlet port 14.

When the engine 11 is initially started, the sealing face 54 of the turbine outlet valve 50 remains in contact with the sealing face 28 of the turbine outlet port 14 to prevent exhaust gas from entering the turbine outlet port 14. Preventing exhaust gas from entering the turbine outlet port 14 directs exhaust gas from the exhaust manifold 26 to the waste port 16. The exhaust gas enters the waste port 16 is directed into the collector 17 and encounters catalyst 20.

The catalyst 20 burns off impurities that may be in the exhaust gas such as unburned fuel or particles prior to discharging the exhaust gas into the atmosphere. Directing the exhaust gas toward the catalyst 20 during engine startup heats the catalyst 20 and improves its ability to purify the exhaust gas.

After a predetermined time of engine operation, the actuator 38 rotates the rod 36 causing the sealing face 54 of the turbine outlet valve 50 to disengage the sealing surface 28 of the turbine outlet port 14. Sufficient rotation of the rod 36 causes the sealing face 54 to fully disengage the sealing surface 28 and causes the sealing face 56 of the waste valve 52 to engage the sealing surface 30 of the waste port 16. In one exemplary embodiment, the turbine outlet port 14 is at an angle relative to the waste port 16. Such a configuration requires the actuator 38 to rotate the rod 36 approximately 90 degrees to fully disengage the turbine outlet valve 50 from the turbine outlet port 14 and to fully engage the waste valve 52 with the waste port 16. In another exemplary embodiment, the sealing surface. 28 of the turbine outlet port 14 is generally parallel to the sealing surface 30 of the waste port 16. Such a configuration requires the actuator 38 to rotate the rod 36 approximately 180 degrees to fully disengage the turbine outlet valve 50 from the turbine outlet port 14 and to fully engage the waste valve 52 with the waste port 16.

In either configuration, rotation of the rod 36 such that the sealing face 56 of the waste valve 52 contacts the sealing surface 30 of the waste port 16 prevents exhaust gas from entering the waste port 16 and directs the exhaust gas into the turbine outlet port 14. It should be understood that while the waste valve 52 is described as completely closing, that the waste port 16 could be partially opened to allow some exhaust gas into the waste port 16 to meter an amount of exhaust gas directed to the collector 17 and catalyst 20. Such metering may be used when engine speeds are relatively high to alleviate the pressure of the exhaust gas received by the expansion device 15.

Once the exhaust gas enters the turbine outlet port 14, the gas encounters the expansion device 15 having a housing 62, a compression mechanism 66, and the turbine 13 disposed generally downstream of the turbine outlet port 14. The exhaust gas first encounters the turbine 13 causing the turbine 13 to rotate relative to the housing 62. Once the exhaust gas has rotated the turbine 13, the exhaust gas is directed to the catalyst 20 for scrubbing prior to being expelled into the atmosphere.

Rotation of the turbine 13 causes concurrent rotation of the compression mechanism 66 relative to the housing 62. Rotation of the compression mechanism 66 draws ambient air into the housing 62 at an inlet 68 for compression by the compression mechanism 66. Once compressed, the air exits the turbocharger 10 via conduit 70 for use in combustion by the engine 11.

As described, the turbocharger 10 includes a turbine housing 12 having a turbine outlet valve 50 and a waste valve 52. The turbine outlet valve 50 closes the turbine outlet port 14 when the engine 11 is initially started to direct all exhaust gas form the exhaust manifold 26 into the waste port 16. Directing the exhaust gas into the waste port 16 allows the gas to heat the catalyst 20 to improve the ability of the catalyst 20 to remove impurities from the exhaust gas prior to expelling the cleansed air into the atmosphere.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A turbine housing for an engine turbocharger comprising:
a turbine outlet port fluidly coupled to an expansion mechanism;
a waste port fluidly coupled to a collector and a catalyst; and
a valve assembly rotatable between a first position blocking said turbine outlet port and a second position blocking said waste port, said valve assembly directing exhaust gas to said waste port in said first position and directing exhaust to said turbine outlet port in said second position;
wherein said valve assembly is in said first position during engine start-up to direct exhaust gas from the engine to said catalyst and in said second position a predetermined time following engine start-up to direct exhaust gas from the engine to said expansion mechanism.

2. The turbine housing of claim 1, wherein said valve assembly includes an outlet port valve matingly received by said turbine outlet port and a waste valve matingly received by said waste port.

3. The turbine housing of claim 2, wherein said outlet port valve includes a first face positioned perpendicular to said turbine outlet port when said valve assembly is in said first position and said waste valve includes a second face positioned perpendicular to said waste port when said valve assembly is in said second position.

4. The turbine housing of claim 3, wherein said first face is formed at an angle relative to said second face.

5. The turbine housing of claim 3, wherein said first face is parallel with said second face.

6. The turbine housing of claim 1, further comprising a shaft extending into the turbine housing to selectively position said valve assembly between said first position and said second position.

7. The turbine housing of claim 6, further comprising an actuator operable to rotate said shaft.

8. The turbine housing of claim 7, wherein said actuator is one of an electric actuator or a pneumatic actuator.

9. The turbine housing of claim 1, wherein said turbine outlet port is formed at an angle relative to said waste port.

10. A turbine housing for an engine turbocharger comprising:
a turbine outlet port;
a waste port;
a turbine outlet valve operable to selectively close said turbine outlet port in a first position to direct exhaust gas into said waste port;
a waste valve operable to selectively close said waste port in a second position to direct exhaust gas into said turbine outlet port; and
a shaft supporting said turbine outlet valve and said waste valve, said shaft rotatable relative to said turbine outlet port and said waste port to selectively position said turbine outlet valve and said waste valve between said first and second positions.

11. The turbine housing of claim 10, wherein said turbine outlet valve is disposed on said shaft at an angle relative to said waste valve.

12. The turbine housing of claim 10, wherein said turbine outlet valve is disposed on said shaft parallel to said waste valve.

13. The turbine housing of claim 10, further comprising an actuator operable to rotate said shaft.

14. The turbine housing of claim 13, wherein said actuator is one of an electric actuator or a pneumatic actuator.

15. The turbine housing of claim 10, wherein said turbine outlet port is formed at an angle relative to said waste port.

16. A method of controlling exhaust gas for a turbocharger associated with an engine, the method comprising:
closing a turbine outlet valve to a turbine associated with the turbocharger to direct the exhaust gas to a waste port;
starting the engine;
directing the exhaust gas from the engine to said waste port for a predetermined time flowing engine start-up;
rotating a shaft following said predetermined time to open said turbine outlet valve and close said waste valve;
directing the exhaust gas from the engine to said turbine;
rotating an expansion mechanism through rotation of said turbine to compress air; and
supplying compressed air to the engine.

17. The method of claim 16, further comprising directing the exhaust gas from said waste gate to a catalyst to light-off fuel in the exhaust gas.

18. The method of claim 17, further comprising releasing said exhaust gas into the atmosphere following said exhaust gas light-off.

19. The method of claim 16, wherein said rotating includes supplying current to an electric actuator.

20. The method of claim 16, wherein said rotating includes supplying air to a pneumatic actuator.
